(19) United States
(12) Patent Application Publication
(10) Pub. No.: US 2025/0183689 A1
(43) Pub. Date: Jun. 5, 2025

(54) DYNAMIC POWER PREDICTION COMMUNICATION INTERFACE

(71) Applicant: Cirrus Logic International Semiconductor Ltd., Edinburgh (GB)

(72) Inventors: Markos KOSEOGLOU, Austin, TX (US); Emmanuel A. MARCHAIS, Dripping Springs, TX (US); Ilija JERGOVIC, Austin, TX (US)

(73) Assignee: Cirrus Logic International Semiconductor Ltd., Edinburgh (GB)

(21) Appl. No.: 18/608,617

(22) Filed: Mar. 18, 2024

Related U.S. Application Data
(60) Provisional application No. 63/605,003, filed on Dec. 1, 2023.

(51) Int. Cl. H02J 7/00

(52) U.S. Cl. CPC H02J 7/0063; H02J 7/0048; H02J 7/00714; H02J 7/007182; H02J 7/007194

(57) ABSTRACT

A system may include a power predictor configured to receive characteristic data relating to a battery for powering a load of a device and based on the characteristic data, generate a plurality of power prediction limits, comprising at least a first power prediction limit comprising information regarding a first available power level for the battery over a first time period and a second power prediction limit comprising information regarding a second available power level for the battery over a second time period. The system May 10 also include a power prediction interface configured to communicate the plurality of power prediction limits to a controller, including updating the first power prediction limit at a first update rate different than a second update rate for updating the second power prediction limit.

### RELATED APPLICATION

The present application claims priority to U.S. Provisional Patent Application 63/605,003, filed Dec. 1, 2023, which is incorporated by reference herein in its entirety.

### FIELD OF DISCLOSURE

The present disclosure relates in general to power management in an electrical or electronic system, and more particularly, to an interface for transmitting dynamic power prediction information from a power prediction subsystem to a power management system, in accordance with embodiments of the present disclosure.

### BACKGROUND

The use of battery-powered devices has become ubiquitous. During operation of a battery-powered electrical and/or electronic system, a condition of a battery (e.g., state of charge, temperature, etc.) may affect the amount of electrical current and power that may be delivered by the battery. Accordingly, to ensure safe and efficient operation of an electrical and/or electronic system, it may be desirable to dynamically predict power capacity of a battery and communicate such capacity to a power management module of the electrical and/or electronic device configured to manage power delivery to components of the electrical and/or electronic device.

### SUMMARY

In accordance with the teachings of the present disclosure, certain disadvantages and problems associated with existing approaches to power management in a battery-operated device may be reduced or eliminated.

In accordance with embodiments of the present disclosure, a method may include receiving characteristic data relating to a battery for powering a load of a device and based on the characteristic data, generating a plurality of power prediction limits, comprising at least a first power prediction limit comprising information regarding a first available power level for the battery over a first time period and a second power prediction limit comprising information regarding a second available power level for the battery over a second time period. The method may further include communicating the plurality of power prediction limits to a controller, including updating the first power prediction limit at a first update rate different than a second update rate for updating the second power prediction limit.

In accordance with these and other embodiments of the present disclosure, a system may include a power predictor configured to receive characteristic data relating to a battery for powering a load of a device and based on the characteristic data, generate a plurality of power prediction limits, comprising at least a first power prediction limit comprising information regarding a first available power level for the battery over a first time period and a second power prediction limit comprising information regarding a second available power level for the battery over a second time period. The system may also include a power prediction interface configured to communicate the plurality of power prediction limits to a controller, including updating the first power prediction limit at a first update rate different than a second update rate for updating the second power prediction limit.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of a battery-operated device, in accordance with embodiments of the present disclosure;

FIG. 2 illustrates a block diagram of an example frame communicated by a power prediction interface, in accordance with embodiments of the present disclosure;

FIG. 3 illustrates a block diagram of an example frame, having power limit and current limit information, communicated by a power prediction interface, in accordance with embodiments of the present disclosure;

FIG. 4 illustrates a block diagram of another example frame communicated by a power prediction interface in a low-power mode, in accordance with embodiments of the present disclosure;

FIG. 5 illustrates a block diagram of an example frame, having power limit and current limit information, communicated by a power prediction interface in a low-power mode, in accordance with embodiments of the present disclosure;

FIG. 6 illustrates a block diagram of example frame sequencing across two channels communicated by a power prediction interface in a high-power mode, in accordance with embodiments of the present disclosure;

FIG. 7 illustrates a block diagram of example frame sequencing across two channels communicated by a power prediction interface in a low-power mode, in accordance with embodiments of the present disclosure; and

FIG. 8 illustrates a block diagram of an example power delivery path for the device of FIG. 1, in accordance with embodiments of the present disclosure.

### DETAILED DESCRIPTION

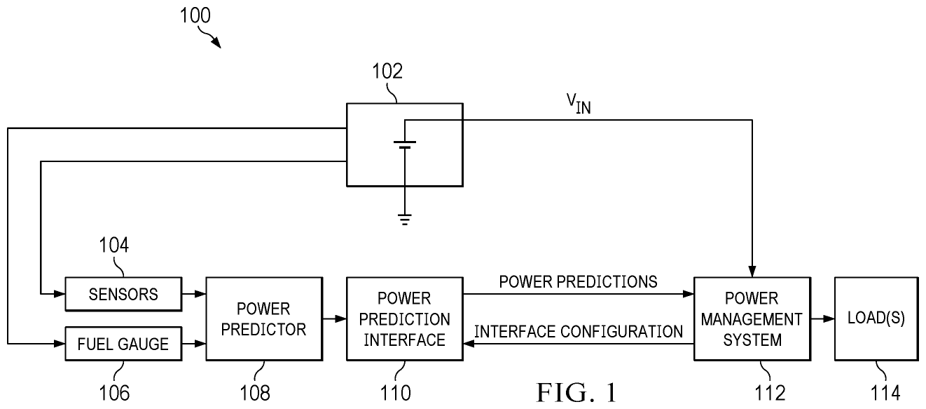

FIG. 1 illustrates a block diagram of a battery-operated device 100, in accordance with embodiments of the present disclosure. As shown in FIG. 1, battery-operated device 100 may include a battery 102, a plurality of sensors 104, a fuel gauge 106, a power predictor 108, a power prediction interface 110, a power management system 112, and one or more electrical and/or electronic loads 114.

Battery 102 may include any system, device, or apparatus configured to convert chemical energy stored within battery 102 to electrical energy. For example, in some embodiments, battery 102 may be integral to a portable electronic device, and battery 102 may be configured to deliver electrical energy to load(s) 114 of device 100. Further, battery 102 may also be configured to recharge, in which it may convert electrical energy received by battery 102 into chemical energy to be stored for later conversion back into electrical energy. As an example, in some embodiments, battery 102 may comprise a lithium-ion battery.

Each sensor 104 may comprise any system, device, or apparatus configured to sense a physical quantity associated with battery 102. For example, sensors 104 may include, without limitation, one or more of a voltage sensor for sensing a terminal voltage across terminals of battery 102, a current sensor for sensing an electrical current delivered by battery 102, and a temperature sensor for sensing a temperature of battery 102. For purposes of clarity and exposition, not all electrical connections between battery 102 and sensors 104 required to perform such sensing are depicted in FIG. 1. However, those of skill in the art will readily recognize how to appropriately couple battery 102 to sensors 104 in order to sense the desired physical quantities.

Fuel gauge 106 may comprise any system, device, or apparatus configured to determine a state of charge of battery 102, i.e., the amount of electrical energy stored in battery 102. Systems and methods for determining a battery state of charge are well known in the art.

Power predictor 108 may comprise any system, device, or apparatus configured to, based on sensor measurements of sensors 104 and battery state of charge determined by fuel gauge 106, dynamically predict power capacity of battery 102. For instance, power capacity may be defined by power prediction horizons and power limits.

A power prediction horizon may define a time duration that a fixed power may be safely drawn from battery 102. For example, a power prediction horizon may define that a fixed power level PL₁ may be safely drawn from battery 102 for a period of time T₁ and another power prediction horizon may define that a fixed power level PL₂ higher than power level PL₁ may be safely drawn from battery 102 for a period of time T₂ shorter than time T₁. With respect to power prediction horizons, “safely” may be defined as a limit that may cause a component or system failure, degraded performance, or reduction in life. For example, the power prediction horizon of time T₁ for fixed power level PL₁ may be based on how much energy may be safely drawn from battery 102 to maintain battery 102 above a threshold terminal voltage.

A power prediction limit may define a maximum power level that may be safely drawn over a fixed time period from battery 102. For example, a power prediction limit may define that a power level PL_{A} may be drawn over a fixed time horizon T_{A} and another power prediction limit may define that a power level PL_{B} lower than power level PL_{A} may be drawn over a fixed time horizon T_{B} longer than time horizon T_{A}.

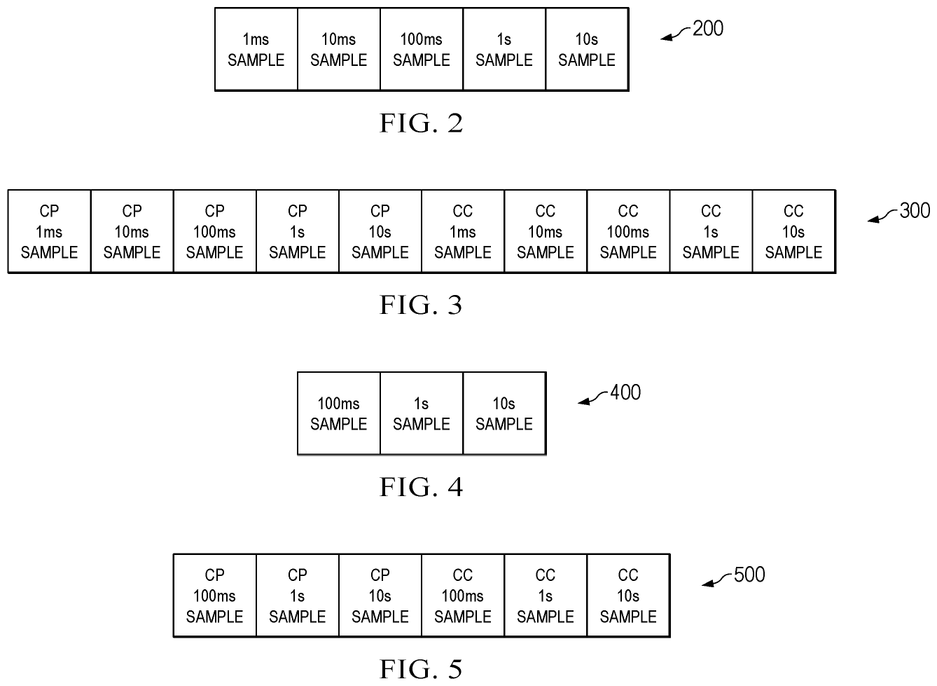

Power prediction interface 110 may comprise a communications interface configured to communicate power predictions (e.g., power prediction horizons, power prediction limits) to power management system 112, as described in greater detail below. As shown in FIG. 2, power prediction interface 110 may receive from power management system 112 interface configuration information. Such interface configuration information may define which power predictions are of interest to power management system 112 and how the communication of power predictions are to be communicated from power prediction interface 110 to power management system 112. For example, interface configuration information may include, without limitation, an identification of the desired power predictions, a data streaming rate of power prediction information to power management system 112, a frame definition of data frames to be communicated to power management system 112, and/or information regarding power modes of power management system 112.

Power management system 112 may comprise any system, device, or apparatus configured to, based on power prediction information received from power prediction interface 110, manage power delivery to load(s) 114. For example, power management system 112 may control delivery of electrical energy from battery 102 to load(s) 114 so as to not violate the power prediction horizons and/or power prediction limits communicated by power prediction interface 110 to power management system 112.

A load 114 may comprise any suitable electrical or electronic component (e.g., loudspeaker, haptic actuator, other actuator, video display, power system, processor, memory, etc.) that may be powered from battery 102.

In operation, power predictor 108 may generate multiple power prediction horizons and/or power prediction limits as defined in power prediction interface 110. Power prediction interface 110 may be configured by power management system 112 to define which predictions are of interest and how the communication of predictions are to be communicated over the interface to power management system 112.

Further, power prediction interface 110 may stream the power predictions to power management system 112. The information streamed from power prediction interface 110 to power management system 112 may include a power prediction limit over a set of prediction horizons, current limits over a set of horizons, or both. The information may also include information indicative of the quality of predictions (e.g., using metrics comparing power prediction for actual system load versus measured load power).

Power prediction interface 110 may stream the information by encoding the information into frames. A stream composed of frames may include information for multiple prediction horizons or different prediction horizons may be communicated via separate streams. In some embodiments, power prediction interface 110 may comprise an electrical interface having one or more serial links. The link(s) may include a single line for carrying clock and data signals, or may include a plurality of lines for carrying a clock signal and one or more data lines. In these and other embodiments, a link may include a separate line for frame synchronization or the synchronization may be encoded into a control and data protocol over a single line.

In turn, power management system 112 may configure or control load(s) 114 to remain below limits set forth in the power predictions.

FIG. 2 illustrates a block diagram of an example frame 200 communicated by power prediction interface 110, in accordance with embodiments of the present disclosure. As shown in FIG. 2, power prediction interface 110 may define example frame 200 to include a set of power predictions for 1 ms to 10s prediction intervals. In some embodiments, power prediction interface 110 may stream frame 200 at ten times the fastest prediction interval (e.g., 10 kHz for example frame 200). In these and other embodiments, power prediction interface 110 may update prediction samples inside frame 200 at ten times the prediction horizon. To minimize computations and power consumption, power prediction interface 110 may hold past updates for slower prediction horizons until a new prediction is available or necessary. For instance, power prediction interface 110 may update a 1-second prediction horizon sample at 10 Hz, and the sample may be held in the faster (e.g., 10 kHz) stream until a new 10 Hz update is available.

A frame may include only power predictions, only current predictions, or both. For instance, as shown by example frame 300 in FIG. 3, power prediction interface 110 may concatenate constant power (CP) and constant current (CC) prediction samples into a single frame 300.

To further minimize power consumption, power prediction interface 110 may increase the prediction horizons and reduce the frame rate of communication in a low power mode (as compared to a high-power or normal mode represented by FIGS. 2 and 3), as demonstrated by example frame 400 in FIG. 4 and example frame 500 in FIG. 5. In such low power mode, power prediction interface 110 may provide only a subset of prediction horizons. Switching between the high-power mode and low-power mode may be controlled by power management system 112, or it may occur automatically when power prediction interface 110 senses an idle load condition (e.g., device 100 enters a low-power mode) or a normal load condition (e.g., device 100 becomes active due to user interaction).

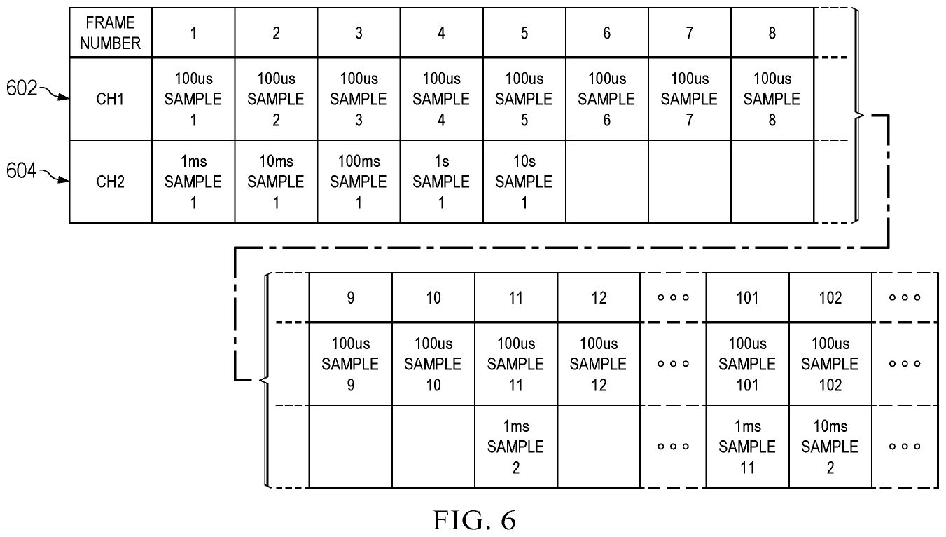

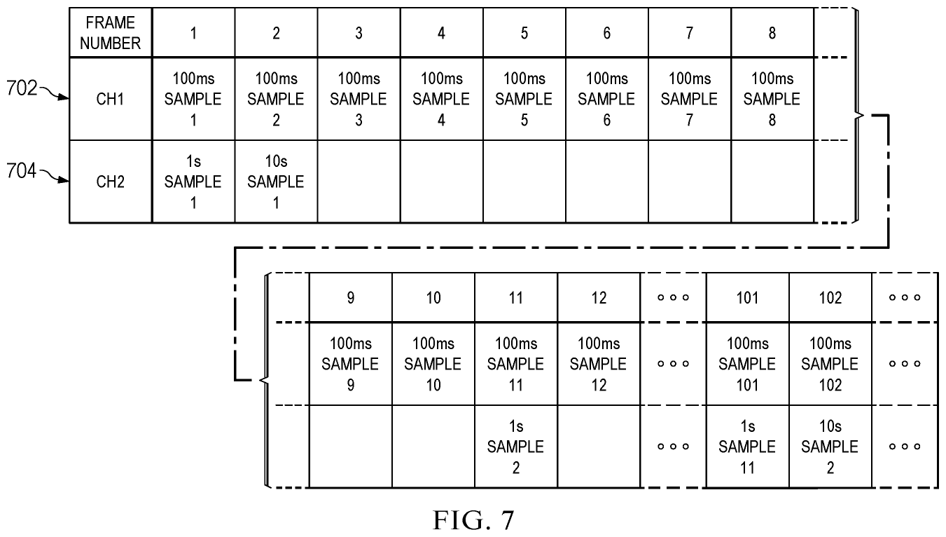

As another example, power prediction interface 110 may stream power predictions over a multi-channel link. For instance, the link may comprise an audio interface or other suitable interface wherein a first channel may stream the shortest prediction horizon and a second channel may stream remaining longer prediction horizons. To illustrate, FIG. 6 depicts example frame sequencing on a first channel 602 and a second channel 604 in a high-power mode, while FIG. 7 depicts example frame sequencing on a first channel 702 and a second channel 704. In FIG. 6, first channel 602 may include a continuous sample stream of a 100-μs interval prediction at a particular frame update rate (e.g., 80 kHz). Second channel 604 may include a stream for all other time interval predictions, synchronized with first channel 602, and with samples dropped on the second channel when no new prediction is ready or available. Similarly, in FIG. 7, first channel 702 may include a continuous sample stream of a 100-ms interval prediction at a particular frame update rate (e.g., 80 Hz). Second channel 704 may include a stream for all other time interval predictions, synchronized with first channel 702, and with samples dropped on the second channel when no new prediction is ready or available.

The foregoing examples are merely illustrations of potential options for streaming by power prediction interface 110, and other streaming formats may be implemented. For example, in some embodiments power prediction interface 110 may define a streaming format that combines control and data and defines multiple concurrent prediction horizon streams operating at different rates with a more complex set of encoding rules.

In these and other embodiments, power prediction interface 110 may dynamically adjust update rates and/or intervals based on interface configuration information received from power management system 112.

As mentioned above, in addition to power prediction information, power prediction interface 110 may also communicate information regarding prediction quality of the power prediction information. Power predictions made by power predictor 108 may be at least partly based on estimating cell impedance of battery 102 from the natural system load. The estimate accuracy may vary over time with the load. Power management system 112 may guard-band power limits based on reported estimates of the prediction quality. Thus, power predictor 108 may determine measurement of the power or voltage prediction error for the system load stimulus as a quality metric. Further, power prediction interface 110 may stream the quality metric in addition to the power prediction information, or power prediction interface 110 may be configured to send an interrupt when the estimated accuracy falls below a particular threshold. The estimated quality may also be a function of fuel gauge states and/or other conditions of battery 102. For instance, at low state of charge (SOC) of battery 102, the accuracy of power predictions may be degraded.

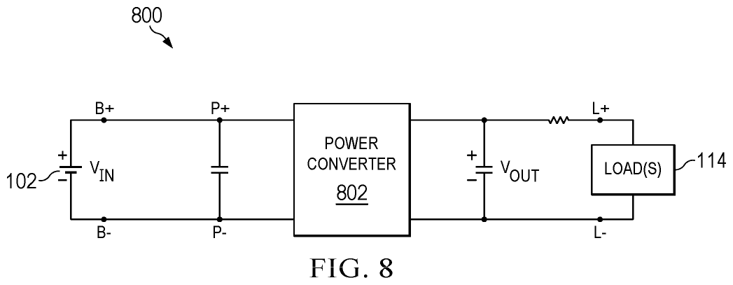

The power predictions made by power predictor 108 and streamed by power prediction interface 110 may relate to power limits for any suitable location with device 100. To illustrate, FIG. 8 illustrates an example power delivery path 800 for device 100, in accordance with embodiments of the present disclosure. As shown in FIG. 8, power delivery path 800 may include battery 102, a power converter 802 configured to convert voltage VIN to an output voltage VOUT, and load(s) 114 coupled to the output of power converter 802.

In some embodiments, power prediction interface 110 may stream predictions of the power available at terminals B+, B− of battery 102. However, in some embodiments, power management system 112 may desire to know power available at the system load point (e.g., nodes L+, L− in FIG. 8) in addition to or in lieu of the battery power at terminals B+, B−. Accordingly, power prediction interface 110 may include a set of configuration parameters to model an impedance network between battery 102 and load(s) 114 and power predictor 108 may simulate the full network (e.g., estimated battery impedance+modeled connection network) to produce a set of predictions of system load power available, streamed over the same interface for the predictions relating to terminals B+, B−. In some instances, the connection network impedance may also be at least partially estimated by monitoring other nodes along the connection network (e.g., P+, P− nodes at the input of power converter 802 and/or node L+, L−).

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A method comprising:
receiving characteristic data relating to a battery for powering a load of a device;
based on the characteristic data, generating a plurality of power prediction limits, comprising at least a first power prediction limit comprising information regarding a first available power level for the battery over a first time period and a second power prediction limit comprising information regarding a second available power level for the battery over a second time period; and
communicating the plurality of power prediction limits to a controller, including updating the first power prediction limit at a first update rate different than a second update rate for updating the second power prediction limit.

2. The method of claim 1, wherein:
the first update rate is based on a first time period associated with the first power prediction limit; and
the second update rate is based on a second time period associated with the second power prediction limit.

3. The method of claim 1, wherein:
the first update rate is inversely proportional to a first time period associated with the first power prediction limit; and
the second update rate is inversely proportional to a second time period associated with the second power prediction limit.

4. The method of claim 1, wherein:
the characteristic data includes data relating to a power delivery path between the battery and the load; and
the plurality of power prediction limits comprises parameters enabling the controller to derive an available power level at a particular location within the power delivery path.

5. The method of claim 1, further comprising:
determining a quality metric associated with the plurality of power prediction limits; and
communicating the quality metric to the controller.

6. The method of claim 1, wherein the characteristic data includes a state of charge of the battery.

7. The method of claim 1, wherein the characteristic data includes one or more of a voltage associated with the battery, an electrical current delivered by the battery, and a temperature associated with the battery.

8. The method of claim 1, further comprising dynamically modifying one or more of the first time period, the second time period, the first update rate, and the second update rate based on interface configuration information received from the controller.

9. A system comprising:
a power predictor configured to:
receive characteristic data relating to a battery for powering a load of a device; and
based on the characteristic data, generate a plurality of power prediction limits, comprising at least a first power prediction limit comprising information regarding a first available power level for the battery over a first time period and a second power prediction limit comprising information regarding a second available power level for the battery over a second time period; and
a power prediction interface configured to communicate the plurality of power prediction limits to a controller, including updating the first power prediction limit at a first update rate different than a second update rate for updating the second power prediction limit.

10. The system of claim 9, wherein:
the first update rate is based on a first time period associated with the first power prediction limit; and
the second update rate is based on a second time period associated with the second power prediction limit.

11. The system of claim 9, wherein:
the first update rate is inversely proportional to a first time period associated with the first power prediction limit; and
the second update rate is inversely proportional to a second time period associated with the second power prediction limit.

12. The system of claim 9, wherein:
the characteristic data includes data relating to a power delivery path between the battery and the load; and
the plurality of power prediction limits comprises parameters enabling the controller to derive an available power level at a particular location within the power delivery path.

13. The system of claim 9, wherein the power prediction interface is further configured to:
determine a quality metric associated with the plurality of power prediction limits; and
communicate the quality metric to the controller.

14. The system of claim 9, wherein the characteristic data includes a state of charge of the battery.

15. The system of claim 9, wherein the characteristic data includes one or more of a voltage associated with the battery, an electrical current delivered by the battery, and a temperature associated with the battery.

16. The system of claim 9, wherein the power prediction interface is further configured to dynamically modify one or more of the first time period, the second time period, the first update rate, and the second update rate based on interface configuration information received from the controller.
